(19) United States
(12) Patent Application Publication
(10) Pub. No.: US 2016/0232139 A1
(43) Pub. Date: Aug. 11, 2016

(54) DEBUGGING DOCUMENT FORMATTING SYSTEM

(71) Applicant: International Business Machines Corporation, Armonk, NY (US)

(72) Inventors: Nicholas L. Brust, Raleigh, NC (US); Bernadette A. Carter, Raleigh, NC (US); Joshua M. Small, Cary, NC (US); Michael K. Sodomsky, Raleigh, NC (US)

(21) Appl. No.: 15/041,705

(22) Filed: Feb. 11, 2016

Related U.S. Application Data
(63) Continuation of application No. 14/618,441, filed on Feb. 10, 2015.

(51) Int. Cl. G06F 17/22; G06F 17/24

(52) U.S. Cl. CPC G06F 17/2247; G06F 17/2288; G06F 17/24

(57) ABSTRACT

A computer receives a document and identifies one or more target elements and/or properties associated with the document, hereafter referred to as targets. The computer detects alterations associated with the targets prior to the computer executing those alterations. If the computer detects an alteration associated with a target, the computer creates a breakpoint and pauses execution of the document prior to executing the alteration. The computer displays the output of the portion of the document executed prior to the alteration, then at the users command executes the portion of the document containing the alteration. The computer displays the output of the portion of the document executed including the portion containing the alteration, providing the user a before and after display of the effect of the alteration. The computer repeats this process for any other detected alterations and allows a user to cycle through the before and after of the alterations.

### TECHNICAL FIELD

The present invention relates generally to document development, and more particularly to debugging styling effects on an HTML document.

### BACKGROUND

Hypertext Markup Language (HTML) documents are used in web page development. As the name suggests, HTML documents contain markup language, or tags. When first introduced, HTML documents were originally intended to only contain tags defining web page content, such as tags separating headings from paragraphs. The introduction of HTML 3.2 greatly expanded the scope of what tags could be included within the HTML markup, including tags defining formatting properties such as text color, background color, font, font size, etc. The introduction of HTML 3.2 resulted in lengthy, complex, and redundant HTML documents where content and presentation tags were intertwined in the HTML markup. To resolve this problem, HTML 4.0 was released and incorporated the capability of utilizing Cascade Style Sheets, or CSS. CSS are used to relocate the formatting tags of an HTML document to a separate CSS file where the HTML tags are rewritten as CSS rules. Relocating the formatting markup to a separate CSS file considerably simplifies the HTML document and enables a single CSS file to define the formatting of multiple documents. While this practice may expedite web page development and simplify HTML documents, applying CSS to an entire HTML document makes debugging specific formatting errors difficult. Furthermore, some formatting errors result from a chain of CSS rules, making it even more difficult to trace formatting errors back to the CSS rule corresponding to the formatting error.

### SUMMARY

Embodiments of the present invention disclose a method, system, and computer program product for a debugging document formatting system. A computer receives a document and identifies one or more target elements and/or properties associated with the document, hereafter referred to as targets. The computer detects alterations to the elements and/or properties associated with the user selected targets, if any, prior to the computer executing those alterations. If the computer detects an alteration to an element and/or property associated with a target, the computer creates a breakpoint and pauses execution of the document prior to executing the alteration. The computer displays the output of the portion of the document executed prior to the alteration, then at the users command executes the portion of the document containing the alteration. After executing the alteration, the computer displays the output of the portion of the document up to and including the portion containing the alteration, providing the user a before and after display of the effect of alteration. The computer repeats this process for any other detected alterations to elements and/or properties associated with the targets and allows a user to cycle through before and after of any of the alterations using selectable arrow buttons within a user interface.

### BRIEF DESCRIPTION OF THE DRAWINGS

FIG. 1 illustrates a debugging document formatting system, in accordance with an embodiment of the invention.

FIG. 2 is a flowchart illustrating the operations of a debugging document formatting program of FIG. 1, in accordance with an embodiment of the invention.

FIG. 3 is a block diagram depicting the hardware components of a debugging document formatting system of FIG. 1, in accordance with an embodiment of the invention.

### DETAILED DESCRIPTION

Embodiments of the present invention will now be described in detail with reference to the accompanying figures.

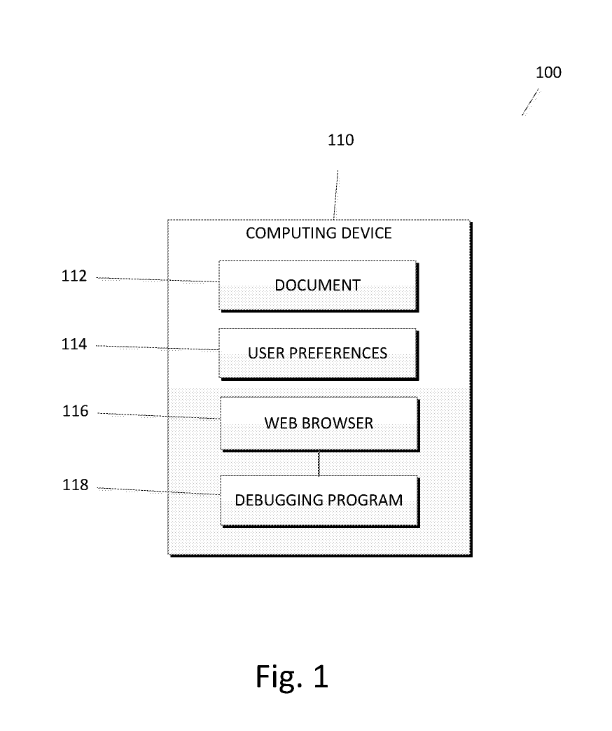

FIG. 1 illustrates a debugging document formatting system 100, in accordance with an embodiment of the invention. In the example embodiment, the debugging document formatting system 100 includes computing device 110.

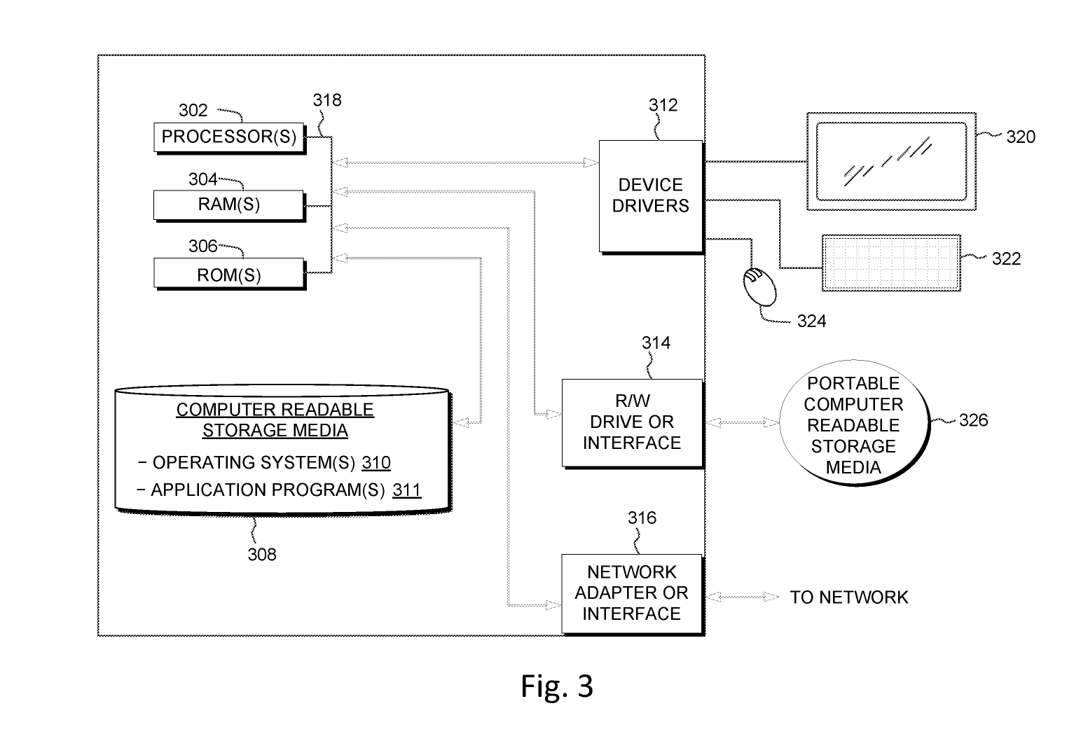

Computing device 110 includes document 112, user preferences 114, web browser 116, and debugging program 118. In the example embodiment, computing device 110 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While computing device 110 is shown as a single device, in other embodiments, computing device 110 may be comprised of a cluster or plurality of computing devices, working together or working separately. Computing device 110 is described in more detail with reference to FIG. 3.

In the example embodiment, document 112 is an HTML document, however, in other embodiments document 112 may be other documents containing markup language compatible with software applications such as Visual Basic (Visual Basic is a registered trademark of Microsoft Corporation), LaTex, or other markup language software. In the example embodiment, document 112 is associated with an external CSS file that defines the formatting of HTML elements contained in document 112. The associated CSS file contains CSS rules defining the formatting of HTML elements contained in document 112, each consisting of a selector, a property, and a value:
CSS Rule=Selector {Property:Value;}
   The selector corresponds to the HTML element that is being formatted, the property corresponds to an attribute of that HTML element, and the value represents the user's selection for that property. For example, if the first header of the document is to be written in blue, the corresponding CSS rule would be written as:
h1 {color:blue;}
   Applying CSS is advantageous for several reasons, perhaps the two biggest being the simplification of the HTML document and the ability to format multiple HTML documents using a single CSS file. In other embodiments, document 112 formatting may be defined by an internal CSS file within the heading of document 112. While both methods produce the same formatting, they differ only in location of the CSS rules.

User preferences 114 is information, received via user input, detailing one or more target elements and/or properties of document 112 the user of computing device 110 seeks to analyze. In the example embodiment, the user of computing device 110 inputs/selects one target element and one target property, collectively referred to as targets. In other embodiments, user preferences 114 may include any number of targets. The user of computing device 110 selects the targets by selecting options corresponding to one or more target elements and/or target properties. In the example embodiment, a user selects the selectable option within the user interface by highlighting the desired target(s) from a list populated with all of the HTML elements and properties contained within document 112. In other embodiments, the user of computing device 110 may select targets by highlighted the target within web browser 116 when applicable. Examples of target elements may include information detailing graphs, charts, links, headings, paragraphs, containers, or other elements contained in document 112. Examples of target properties may include information detailing size, color, font, margin, padding, or other presentation characteristics associated with document 112.

Web browser 116 is a software application capable of opening documents, such as HTML documents, on computing device 110. In the example embodiment, web browser 116 is capable of communicating with other computing devices via a network and is integrated with debugging program 118.

In the example embodiment, debugging program 118 is a software application fully integrated with web browser 116, however, in other embodiments, debugging program 118 may be partially integrated or not integrated with web browser 116. Debugging program 118 is capable of detecting document 112 and receiving user preferences 114. Debugging program 118 is also capable of interpreting code within a document prior to the code being executed by software applications, such as interpreting whether targets contained in document 112 will be altered by a CSS rule before they are executed by web browser 116. Debugging program 118 is also capable of creating a breakpoint that pauses execution when a condition is met, such as pausing the execution of document 112 by web browser 116 when a target is about to be altered. Furthermore, debugging program 118 is capable of visually displaying the target before and after the alteration.

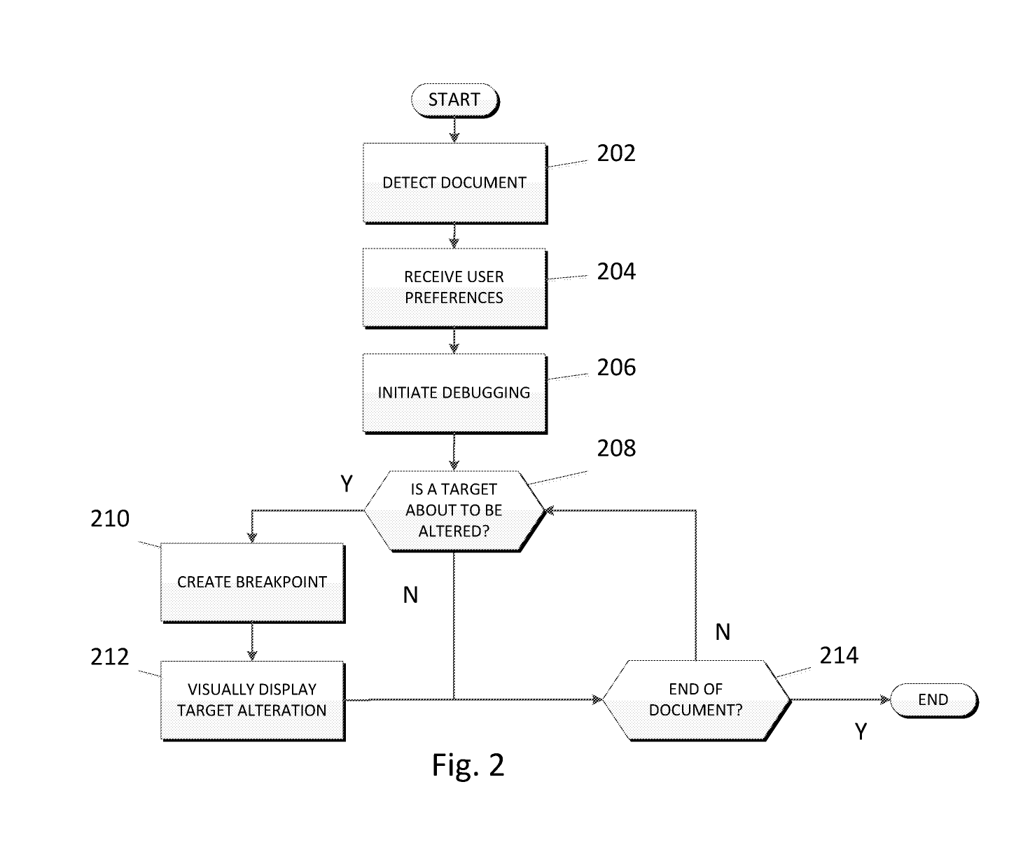

FIG. 2 is a flowchart depicting the operation of debugging program 118 in creating a breakpoint prior to a target being altered, in accordance with an embodiment of the present invention. In the example embodiment where debugging program 118 is fully integrated with web browser 116 (and in embodiments where debugging program 118 is partially integrated with web browser 116), debugging program 118 detects initiation of execution of document 112 by way of full (or partial) integration with web browser 116 (step 202). In other embodiments where debugging program 118 is not integrated with web browser 116, debugging program 118 detects initiation of execution of document 112 by way of communication with the operating system of computing device 110 or by way of user input. In the example embodiment, document 112 is stored in local memory, however, in other embodiments, document 112 may be stored remotely and retrieved by debugging program 118 via a network.

Debugging program 118 receives user preferences 114, denoting the targets a user wishes to analyze contained in document 112 (step 204). In the example embodiment, the user of computing device 110 selects targets by choosing a selectable option(s) corresponding to one or more target elements and/or target properties within web browser 116. For example, refer to the example above which illustrates a CSS rule defining the color of the first heading of document 112 as blue. The user of computing device 110 may select the first heading as a target by selecting a selectable option corresponding to the first heading or selecting (or highlighting) the first heading itself within web browser 116. The user of computing device 110 may select a target property, such as color, by selecting a selectable option corresponding to the color of the first heading. In other embodiments, the user of computing device 110 may select targets by choosing selectable options(s) corresponding to one or more target elements and/or target properties within document 112 or via a prompt displayed to the user by debugging program 118. Additionally, in other embodiments, the user of computing device 110 may select only target element(s) or only target property/properties or both in a similar manner as described above.

In the example embodiment where debugging program 118 is fully integrated with web browser 116 (and in embodiments where debugging program 118 is partially integrated with web browser 116), debugging program 118 initiates debugging upon detecting the opening of document 112 by web browser 116 (step 206). In other embodiments where debugging program 118 is not integrated with web browser 116, debugging program 118 may initiate debugging by way of user input.

In the example embodiment, debugging program 118 detects if a target would be altered by execution of document 112 by web browser 116. Debugging program detects if a target is about to be altered by interpreting the language contained in document 112 prior to it being executed by web browser 116 (decision 208). In the example embodiment, debugging program 118 interprets the content of document 112 several lines ahead of web browser 116 executing document 112. Referring to the example above, debugging program 118 interprets the content of document 116 listening for alterations to the color of the first heading of document 112. Because the user of computing device 110 selected both a target element (the first heading of document 112) and a target property (the color of the first heading), debugging program only listens for alterations specific to the color of the first heading of document 112. However, if the user of computing device 110 had only selected a target element (the first heading of document 112), debugging program 118 would listen for any alteration to the first heading of document 112. Similarly, if the user of computing device 110 selected only a target property (color), debugging program 118 would listen for any change in color to any element throughout entire document 112.

If debugging program 118 does not detect that a target is about to be altered (decision 208, “NO” branch), debugging program 118 will determine whether the document has been executed in entirety (decision 214). In the example embodiment where debugging program 118 is fully integrated with web browser 116 (and in embodiments where debugging program 118 is partially integrated with web browser 116), debugging program 118 determines whether the document has been executed in entirety by way of full (or partial) integration with web browser 116. In other embodiments where debugging program 118 is not integrated with web browser 116, debugging program 118 determines whether the document has been executed in entirety by way of communication with the operating system or prompting the user for user input.

If debugging program 118 detects that a target is about to be altered (decision 208, “YES” branch), debugging program 118 creates a breakpoint and pauses execution of document 112 by web browser 116 prior to executing the alteration (step 210). Continuing the example above where the first heading of document 112 has been selected as a target element and the color of that first heading is the target property, if debugging program 118 detects that the color of the first heading is about to be altered from the color blue to the color purple, debugging program 118 creates a breakpoint and pauses the execution of document 112 prior to web browser 116 applying any alteration to the color of the first heading contained in document 112.

After detecting that a target is about to be altered (decision 208) and creating a breakpoint (step 210), debugging program 118 will visually display the alteration of the target(s) (step 212). Utilizing the interface of web browser 116, debugging program 118 will display the elements, such as elements of a web page, corresponding to the portion of document 112 executed before the breakpoint. Similarly, debugging program 118 will also highlight the CSS rule which will cause the alteration to the target. Continuing the example above, debugging program 118 will display the portions of document 112 executed up to the color of the first heading being altered. Because the alteration has not yet been executed, the breakpoint allows the user to see the output of document 112 before the alteration associated with the color of the first heading is applied. The user may then step over, or execute, the CSS rule altering the color of the first heading and view the output of document 112 after the altering the color of the first heading. Using the breakpoint, debugging program 118 displays to the user of computing device 102 the web browser 116 output of document 112 before and after altering the color of the first heading of document 112. Additionally, debugging program 118 will display the CSS rule in the CSS file that corresponds to the alteration. In other embodiments utilizing an internal CSS file, the CSS rule corresponding to the color of the first heading of document 112 will be displayed in the internal CSS file within the HTML document.

If the entire document 112 has been executed (decision 214 “YES” branch), the debugging process is complete. The user of computing device 110 may cycle forward and backward through the before and after of each breakpoint using selectable arrow buttons within the user interface.

If debugging program 118 determines there is additional content in document 112 that has not been executed by web browser 116 (decision 214 “NO” branch), debugging program 118 interprets the remaining code of document 112 until debugging program 118 again detects that a target is about to be altered (decision 208) or until the document is executed in entirety (decision 214).

FIG. 3 depicts a block diagram of components of computing device 110 of a debugging document formatting system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 may include one or more processors 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311, for example, debugging program 118, are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 314 to read from and write to one or more portable computer readable storage media 326. Application programs 311 on computing device 110 may be stored on one or more of the portable computer readable storage media 326, read via the respective R/W drive or interface 314 and loaded into the respective computer readable storage media 308.

Computing device 110 may also include a network adapter or interface 316, such as a TCP/IP adapter card or wireless communication adapter (such as a 4G wireless communication adapter using OFDMA technology). Application programs 311 on computing device 110 may be downloaded to the computing device from an external computer or external storage device via a network (for example, the Internet, a local area network or other wide area network or wireless network) and network adapter or interface 316. From the network adapter or interface 316, the programs may be loaded onto computer readable storage media 308. The network may comprise copper wires, optical fibers, wireless transmission, routers, firewalls, switches, gateway computers and/or edge servers.

Computing device 110 may also include a display screen 320, a keyboard or keypad 322, and a computer mouse or touchpad 324. Device drivers 312 interface to display screen 320 for imaging, to keyboard or keypad 322, to computer mouse or touchpad 324, and/or to display screen 320 for pressure sensing of alphanumeric character entry and user selections. The device drivers 312, R/W drive or interface 314 and network adapter or interface 316 may comprise hardware and software (stored on computer readable storage media 308 and/or ROM 306).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

Various embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for a debugging document formatting, the method comprising:
receiving, by a computer, a document;
identifying, by the computer, at least one target associated with the document;
executing, by the computer, a first portion of the document and corresponding Cascade Style Sheets (CSS) rules, wherein execution of the first portion of the document and the corresponding CSS rules result in one or more elements associated with the at least one target, and wherein the CSS rules corresponding to the first portion of the document define formatting characteristics associated with the first portion of the document;
interpreting, by the computer, a second portion of the document and corresponding CSS rules prior to the computer executing the second portion of the document and the corresponding CSS rules in order to determine whether execution of the second portion of the document and corresponding CSS rules result in alteration of the one or more elements of the document associated with the at least one target, wherein the CSS rules corresponding to the second portion of the document define formatting characteristics associated with the second portion of the document;
based on determining that execution of the second portion of the document and corresponding CSS rules result in alteration of the one or more elements of the document associated with the at least one target, creating, by the computer, a breakpoint; and
in response to creating the breakpoint:
displaying, by the computer, a first display comprising: i) the one or more elements of the document based on the executed first portion of the document and the CSS rules corresponding to the first portion of the document, and ii) the CSS rules corresponding to the first portion of the document;
executing, by the computer, the second portion of the document and the CSS rules corresponding to the second portion of the document;
displaying, by the computer, a second display comprising: i) the one or more elements of the document based on the executed first portion of the document and CSS rules corresponding to the first portion of the document as well as the executed second portion of the document and the CSS rules corresponding to the second portion of the document, ii) the CSS rules corresponding to the first portion of the document, and iii) the CSS rules corresponding to the second portion of the document; and
highlighting within the second display, by the computer, the CSS rules corresponding to the second portion of the document based on determining that execution of the second portion of the document and corresponding CSS rules result in alteration of the one or more elements of the document associated with the at least one target.
